(19) United States
(12) Patent Application Publication
(10) Pub. No.: US 2025/0060585 A1
(43) Pub. Date: Feb. 20, 2025

(54) PROVIDING A UTILITY VEHICLE WITH A VIEW OF ELECTRONIC INFORMATION AT WINDSHIELD-LEVEL

(71) Applicant: Textron Innovations Inc., Providence, RI (US)

(72) Inventor: Brian David Wanta, North Augusta, SC (US)

(21) Appl. No.: 18/233,551

(22) Filed: Aug. 14, 2023

(51) Int. Cl. G02B 27/01; B60K 35/00

(52) U.S. Cl. CPC G02B 27/0101; B60K 35/00; G02B 27/0179; B60K 35/23; B60K 2360/334; G02B 2027/014; G02B 2027/0185

(57) ABSTRACT

A golf cart includes a golf cart body and a golf cart windshield supported by the golf cart body. The golf cart windshield is constructed and arranged to provide a driver of the golf cart with a windshield view of an environment in front of the golf cart. The golf cart further includes a windshield-level display device coupled with the golf cart body. The windshield-level display device is constructed and arranged to provide the driver of the golf cart with an electronic view of golf cart information. The windshield view of the environment in front of the golf cart and the electronic view of the golf cart information are provided at a same height to the driver of the golf cart. Additionally, the electronic view is provided at a predefined distance above a bottom of the windshield view.

### BACKGROUND

Conventional golf carts carry golfers and their golf clubs around golf courses. Such a golf cart enables a golfer to play golf on a golf course without having to walk the entire golf course.

Some conventional golf carts have LCD monitors that extend from the rooflines or from the steering columns of the golf carts. A golfer looking away from a windshield area of such a golf cart and toward the LCD monitor of the golf cart is able to view the LCD monitor.

### SUMMARY

Unfortunately, when an LCD monitor extends from the roofline or from the steering column of a golf cart, viewability of the LCD monitor is sub-optimal. Along these lines, in order to view the LCD monitor, the driver must look away from the windshield area of the golf cart. Accordingly, the LCD monitor is not well-suited for viewing by a golfer that is currently driving the golf cart.

Advantageously, improved techniques are directed to providing a driver of a utility vehicle (e.g., a golf cart) with a view of electronic information which is at windshield-level. That is, the utility vehicle may include a windshield (or windshield section) that provides the driver with a windshield view of an environment in front of the vehicle. Additionally, a windshield-level display device provides an electronic view of electronic information. Both the windshield view of the environment in front of the vehicle and the electronic view of the electronic information are provided at a same height to the driver of the vehicle. Accordingly, the driver does not need to look away from the windshield and may instead see the electronic view while still focusing on the path ahead. In some embodiments, the electronic view is positioned at a predefined or adjustable height above the dashboard of the utility vehicle (e.g., six inches, eight inches, etc.) to enable the driver to easily see the electronic view above the steering wheel of the utility vehicle.

One embodiment is directed to a golf cart which includes a golf cart body and a golf cart windshield supported by the golf cart body. The golf cart windshield is constructed and arranged to provide a driver of the golf cart with a windshield view of an environment in front of the golf cart. The golf cart further includes a windshield-level display device coupled with the golf cart body. The windshield-level display device is constructed and arranged to provide the driver of the golf cart with an electronic view of golf cart information. The windshield view of the environment in front of the golf cart and the electronic view of the golf cart information are provided at a same height to the driver of the golf cart, and the electronic view is provided at a predefined distance above a bottom of the windshield view.

In some arrangements, the golf cart further includes a mobile client device which couples with the windshield-level display device. The mobile client device is constructed and arranged to provide an electronic display signal to the windshield-level display device to render the golf cart information.

Another embodiment is directed to a windshield-level display kit for a golf cart having a golf cart body and a golf cart windshield supported by the golf cart body. The golf cart windshield is constructed and arranged to provide a driver of the golf cart with a windshield view of an environment in front of the golf cart. The windshield-level display kit includes:
(A) a windshield-level display device constructed and arranged to couple with the golf cart body, and to provide the driver of the golf cart with an electronic view of golf cart information, the windshield view of the environment in front of the golf cart and the electronic view of the golf cart information being provided at a same height to the driver of the golf cart, and the electronic view being provided at a predefined distance above a bottom of the windshield view; and
(B) a mobile client device which couples with the windshield-level display device, the mobile client device being constructed and arranged to provide an electronic display signal to the windshield-level display device to render the golf cart information.

Yet another embodiment is directed to a method of providing a driver of a golf cart with an electronic view of golf cart information. The golf cart has a golf cart body and a golf cart windshield supported by the golf cart body. The golf cart windshield is constructed and arranged to provide the driver of the golf cart with a windshield view of an environment in front of the golf cart. The method includes:
(A) coupling a windshield-level display device with the golf cart body, the windshield-level display device being constructed and arranged to provide the driver of the golf cart with the electronic view of the golf cart information, the windshield view of the environment in front of the golf cart and the electronic view of the golf cart information being provided at a same height to the driver of the golf cart, and the electronic view being provided at a predefined distance above a bottom of the windshield view;
(B) coupling a mobile client device with the golf cart body, the mobile client device being constructed and arranged to provide an electronic display signal to the windshield-level display device to render the golf cart information; and
(C) electronically connecting the windshield-level display device with the mobile client device.

In some arrangements, the method further includes, in response to the electronic display signal, displaying the golf cart information on the windshield-level display to the driver while the golf cart is in motion. Here, the driver is able to easily access the displayed golf cart information while viewing what is ahead and driving the golf cart.

In some arrangements, the method further includes adjusting the predefined distance above the bottom of the windshield view from a first height to a second height that is different from the first height to move the electronic view within the windshield view. For example, the electronic view may be moved from a first height of eight inches above the bottom of the windshield view to a second height of 12 inches above the bottom of the windshield view, or vice versa.

In some arrangements, the golf cart body of the golf cart includes (i) a canopy that serves as a roof to the golf cart and (ii) a golf cart dashboard. Additionally, the windshield view of the environment in front of the golf cart and the electronic view of the golf cart information reside at a height which is above the golf cart dashboard and at least eight inches below the canopy.

In some arrangements, the windshield-level display device includes a projection apparatus that is constructed and arranged to project the golf cart information on to the golf cart windshield in response to the electronic display signal.

In some arrangements, the windshield-level display device includes an electronic screen that is constructed and arranged to display the golf cart information in place of a portion of the windshield view in response to the electronic display signal.

In some arrangements, the mobile client device includes global positioning system (GPS) circuitry and a controller. Additionally, the GPS circuitry is constructed and arranged to identify a current geolocation of the golf cart. Furthermore, the controller is constructed and arranged to identify a current golf course hole of a golf course and include hole information within the electronic display signal that is provided to the windshield-level display device based on the current geolocation of the golf cart.

In some arrangements, the hole information that is included within the electronic display signal includes an identification of the current golf course hole, an overall distance for the current golf course hole, and a current distance between the golf cart and a pin location of the current golf course hole based on the current geolocation.

In some arrangements, the mobile client device includes global positioning system (GPS) circuitry and a controller. Additionally, the GPS circuitry is constructed and arranged to identify a current geolocation of the golf cart. Furthermore, the controller is constructed and arranged to identify a current golf course and include course information within the electronic display signal that is provided to the windshield-level display device based on the current geolocation of the golf cart.

In some arrangements, the course information that is included within the electronic display signal includes an identification of the current golf course and a set of geofenced areas surrounding the golf cart based on the current geolocation.

In some arrangements, the mobile client device includes a controller which is constructed and arranged to include a set of displayable messages within the electronic display signal that is provided to the windshield-level display device.

In some arrangements, the set of displayable messages include golf course sponsors, advertisements, and real-time weather updates.

Other embodiments are directed to systems, subsystems, apparatus, assemblies, and so on. Some embodiments are directed to various methods, componentry, platforms, crafts, etc. which are involved in providing a view of electronic information at windshield-level.

### BRIEF DESCRIPTION OF THE DRAWINGS

The foregoing and other objects, features and advantages will be apparent from the following description of particular embodiments of the present disclosure, as illustrated in the accompanying drawings in which like reference characters refer to the same parts throughout the different views. The drawings are not necessarily to scale, emphasis instead being placed upon illustrating the principles of various embodiments of the present disclosure.

FIG. 1 is a diagram of an example vehicle which provides a view of electronic information at windshield-level in accordance with certain embodiments.

FIG. 2 is a diagram of a windshield-level display device in accordance with certain embodiments.

FIG. 3 is a diagram of another windshield-level display device in accordance with certain embodiments.

FIG. 4 is a diagram of a windshield-level display kit in accordance with certain embodiments.

FIG. 5 is a flowchart of a procedure for providing a driver with a view of electronic information which is at windshield-level in accordance with certain embodiments.

### DETAILED DESCRIPTION

An improved technique is directed to providing a driver of a utility vehicle such as a golf cart with a view of electronic information which is at windshield-level. Along these lines, the utility vehicle may include a windshield that provides the driver with a windshield view of an environment in front of (or ahead of) the vehicle. Additionally, a windshield-level display device provides an electronic view of electronic information. Both the windshield view of the environment in front of the vehicle and the electronic view of the electronic information are provided at a same height to the driver of the vehicle. For example, the electronic view may be positioned at a predefined or adjustable height above the vehicle dashboard thus enabling the driver to conveniently see the electronic view above the vehicle steering wheel. Accordingly, the driver does not need to look away from the windshield and may instead see the electronic view while still focusing on the path ahead.

The various individual features of the particular arrangements, configurations, and embodiments disclosed herein can be combined in any desired manner that makes technological sense. Additionally, such features are hereby combined in this manner to form all possible combinations, variants and permutations except to the extent that such combinations, variants and/or permutations have been expressly excluded or are impractical. Support for such combinations, variants and permutations is considered to exist in this document.

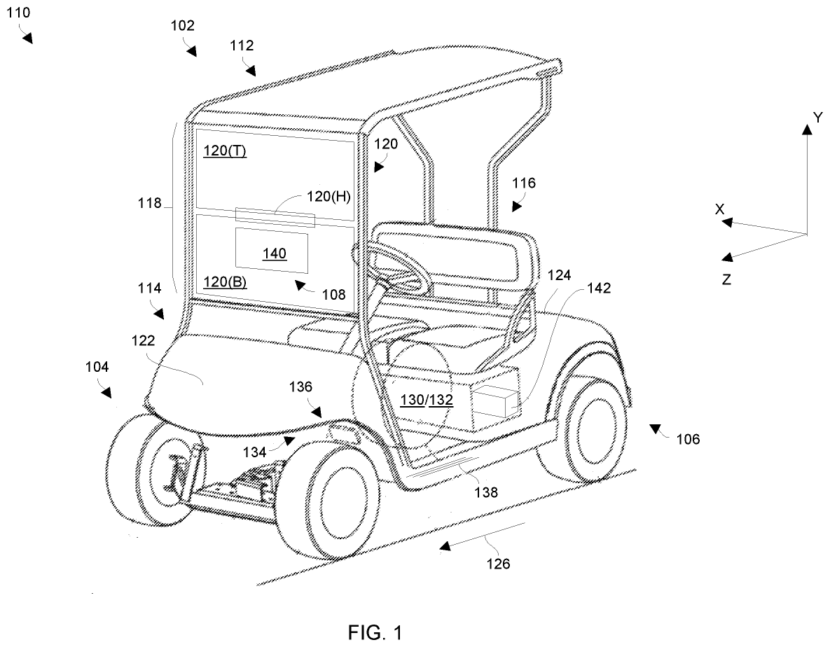

FIG. 1 is a diagram of an example utility vehicle 100 which provides a driver with a view of electronic information which is at windshield-level in accordance with certain embodiments. The utility vehicle 100 includes a utility vehicle body 102 (e.g., a chassis, a frame, etc.), a set of engagement members 104 (e.g., a set of tires), a motion control system 106, and windshield-level display equipment 108. It should be understood that the utility vehicle 100 has the form factor of a golf car by way of example only and that other utility vehicle form factors are suitable for use as well such as those of personnel and/or cargo transport vehicles, food and beverage vehicles, hospitality vehicles, all-terrain vehicles (ATVs), utility task vehicles (UTVs), tracked vehicles, larger specialized equipment and/or application vehicles, motorcycles, scooters, as well as other lightweight and/or special purpose vehicles.

The utility vehicle body 102 includes a variety of sections 110 such as a canopy section 112, a dashboard section 114, a seating section 116, and so on. The canopy section 112 serves as a roof of the utility vehicle 100 to protect one or more vehicle passengers sitting in (or on) the seating section 116. Additionally, the canopy section 112 and the dashboard section 114 define a windshield section 118 therebetween. As will be explained in further detail shortly, passengers (including a driver) are able to see, as a windshield view, the environment ahead of the utility vehicle 100 through the windshield section 118.

In some embodiments, the utility vehicle 100 includes an actual windshield 120 disposed within the windshield section 118 and supported by the utility vehicle body 102. Along these lines, the windshield 120 may be a sheet of transparent material (e.g., acrylic, plexiglass, other plastics, etc.) through which passengers are able to see an environment in front of the utility vehicle 100.

In some arrangements, the windshield 120 includes a top portion 120(T), a bottom portion 120(B), and a hinge portion 120(H). This arrangement enables the windshield 120 to selectively reside in an extended configuration that predominantly covers the windshield section 118 and a folded configuration in which the top portion 120(T) is folded outward and over the bottom portion 120(B) via the hinge portion 120(H). In both configurations, the passengers are able to view the environment ahead of the utility vehicle 100. For example, a golf cart windshield may include two flat transparent plastic panels which are held in place by rubber members on the sides and/or bottoms.

It should be further understood that the utility vehicle body 102 defines a vehicle front (or hood) 122 and a vehicle back 124. Accordingly, when the utility vehicle 100 moves forward, the utility vehicle 100 is considered to move in a front-to-back direction (see arrow 126 pointing in the positive Z-direction).

The set of engagement members 104 is constructed and arranged to interact with the environment to move the utility vehicle 100. It should be understood that various types of engagement members 104 are suitable for use (e.g., tires/wheels, tracks, rails, propellers, combinations thereof, etc.) depending on the type of environment or terrain (e.g., a road, dirt, brush, snow, ice, marsh, water, etc.).

The motion control system 106 is constructed and arranged to control vehicle movement such as drive provided by the set of engagement members 104, speed control, braking, and so on thus enabling the utility vehicle 100 to effectively maneuver and perform useful work. The motion control system 106 may include, among other things, a motor system 130, a battery management system 132, and additional components 134 such as a set of user controls 136 (e.g., a steering wheel, foot pedals, transmission control, a keyed switch, a maintenance switch, additional levers/knobs/etc.), cabling 138, and so on.

It should be understood that certain components of the motor control system 106 (or portions thereof) may be disposed within a set of compartments (in one or more compartments) under a set of seats (under one or more seats) of the utility vehicle 100. For example, a compartment underneath a seat of the utility vehicle 100 may house one or more rechargeable batteries, control circuitry, cabling, controls, etc. for ease of access/serviceability, to protect passengers, for protection against damage, for security, and so on. Other locations are suitable for use as well such as under a hood, under a rear bed, etc.

It should be further understood that the motion control system 106 includes other apparatus/components as well. Along these lines, the motion control system 106 further includes a drivetrain (e.g., a set of gears, linkage, differential, etc.) that connects the motor system 130 to the set of engagement members 104 (e.g., two drive wheels and two non-drive wheels), a steering wheel (or column), a steering gear set that connects the steering wheel to certain engagement members 104, a set of brakes, other controls and sensors, and so on.

The windshield-level display equipment 108 includes a windshield-level display device 140 and a mobile client device 142. The windshield-level display device 140 and the mobile client device 142 couple with each other to enable the windshield-level display device 140 to operate based on an electronic display signal from the mobile client device 142.

In some arrangements, the windshield-level display device 140 and the mobile client device 142 are co-located (e.g., within the same housing, fully integrated, physically attached to each other, etc.). In other arrangements, the windshield-level display device 140 and the mobile client device 142 reside at different locations on the utility vehicle body 102 (e.g., see FIG. 1).

The windshield-level display device 140 is constructed and arranged to couple with (or attach to) the utility vehicle body 102, and to provide a driver of the utility vehicle 100 with an electronic view of utility vehicle information. The windshield view of the environment in front of the utility vehicle 100 and the electronic view of the utility vehicle information are provided at a same height (or height range) to the driver of the utility vehicle 100.

Such a height range (e.g., as measured along the Y-axis in FIG. 1) may start a certain distance from below the canopy section 112 (or roofline) such as several inches (e.g., at least 6 inches, 8 inches, 10 inches, etc.). Additionally, the height range may extend down to the bottom of the windshield section 118 or just an inch or two above the bottom of the windshield section 118. For example, the height range for the windshield-level display may be from midway of the bottom half 120(B) of the windshield 120 to just above the bottom of the windshield section 118 (see FIG. 1). Accordingly, the driver does not need to turn away from the windshield view in order to see the electronic view. Rather, since the electronic view is within the windshield view in accordance with certain embodiments, the driver of the utility vehicle 100 is able to take in both views without having to move.

It should be understood that distance of the electronic view above the bottom of the windshield view may be controlled to enable the driver to observe the electronic view without steering wheel interference. Along these lines, the electronic view may be X inches above the bottom of the windshield view (e.g., six inches, eight inches, 10 inches, etc.). In accordance with certain embodiments, this distance may be adjusted to accommodate different driver viewing heights.

The mobile client device 142 is constructed and arranged to provide the electronic display signal to the windshield-level display device 140 to render utility vehicle information (e.g., locations of restricted geofenced areas in the vicinity of the utility vehicle 100, weather reports local to the geolocation of the utility vehicle 100, messages from a central station, combinations thereof, etc.). In the context of a golf cart that is constructed and arranged to maneuver over a golf course, the mobile client device 142 is constructed and arranged to provide the electronic display signal to the windshield-level display device 140 to render golf cart information based on a current geolocation of the golf cart (e.g., a particular golf hole, hole distances, distances to the pin, pace of play, etc.).

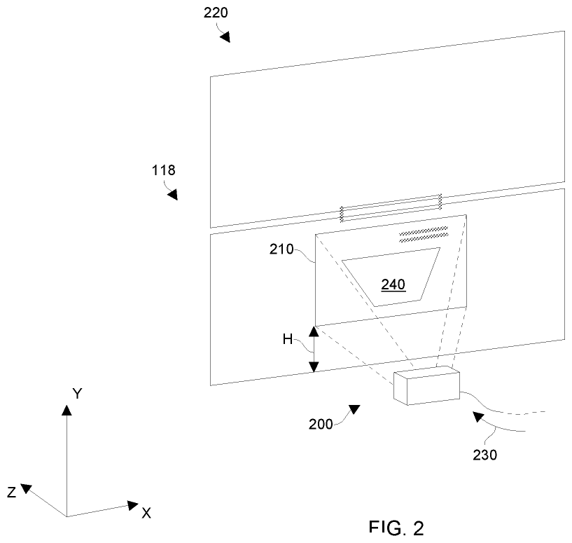

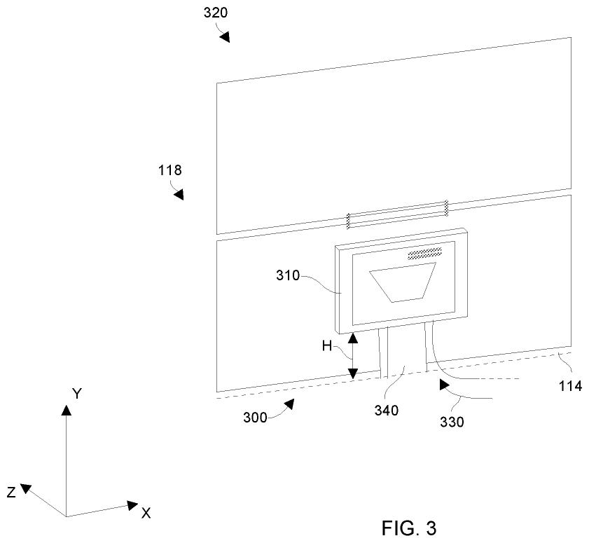

As will be explained in further detail shortly, the mobile client device 142 may be equipped to perform other operations. Along these lines, the mobile client device 142 includes geolocation identification circuitry to identify the current geolocation of the utility vehicle 100, e.g., a global positioning system (GPS) circuit. Once the mobile client device 142 is able to identify the current geolocation of the utility vehicle 100, the mobile client device 142 is able to output related information on the electronic view, as well as perform other operations based on geolocation (e.g., restrict speed of the utility vehicle 100, disable the utility vehicle 100, sound an alert, etc.). Further details will now be provided with reference to FIGS. 2 and 3.

FIGS. 2 and 3 show certain embodiments for windshield-level display devices which are suitable for the windshield-level display equipment 108 of the utility vehicle 100 (also see the windshield-level display device 140 in FIG. 1). FIG. 2 shows a windshield-level display device 200 in accordance with some embodiments. FIG. 3 shows a windshield-level display device 300 in accordance with some embodiments.

As shown in FIG. 2, the windshield-level display device 200 is a projector style apparatus which presents a projection 210 containing utility vehicle information onto a windshield 220 (also see the windshield 120 in FIG. 1). The windshield-level display device 200 may be constructed and arranged to receive an electronic display signal 230 and render the projection 210 (i.e., an electronic view of the utility vehicle information) based on the electronic display signal 230.

In some arrangements, the windshield-level display device 200 is constructed and arranged to reside between the windshield section 118 of the utility vehicle 100 and the seating section 116 of the utility vehicle 100 (e.g., see FIG. 1). As illustrated in FIG. 2, the electronic view may be positioned within the windshield view at a height (H) (e.g., six inches, eight inches, etc.) above a bottom of the windshield view (or above the bottom of the windshield section 118, or the above the top of the dashboard section 114, etc.) thus enabling the driver to easily see the electronic view above the steering wheel of the vehicle 100. In these arrangements, the windshield-level display device 200 outputs light in a forward direction (the positive Z-direction in FIG. 2) toward the windshield 220 enabling passengers to view information as the projection 210 reflects off the windshield 220. Such arrangements are well suited for situations in which the windshield-level display device 200 is able to conveniently or easily mount in front of the windshield 220 (e.g., on top of a dashboard, on a steering column, etc.). Along these lines, a golf cart dashboard may include a durable upper hull (e.g., formed of fiberglass, plastic, etc.) on which the windshield-level display device 200 is easily attached (e.g., via hardware, brackets, etc.).

In other arrangements, the windshield section 118 of the utility vehicle 100 resides between the windshield-level display device 200 and the seating section 116 of the utility vehicle 100 (e.g., see in FIG. 1). In these arrangements, the windshield-level display device 200 outputs light in a rearward direction (the negative Z-direction in FIG. 2) toward the windshield 220 enabling passengers to view information as the projection 210 refracts through the windshield 220. Such arrangements are well suited for situations in which the windshield-level display device 200 is able to conveniently/easily mount on the other side of the windshield 220 (e.g., on a front portion of the utility vehicle body 102, on a hood of the utility vehicle 100, etc.).

It should be understood that the windshield-level display device 200 may be provisioned with one or more optical features to output the projection 210 onto the windshield 220 (e.g., a lens, an LED array, an LCD array, a miniature display screen, via lasers, combinations thereof, etc.). In some arrangements, the windshield-level display device 200 may be configured to provide the projection 210 from a side, a top, and/or a bottom of a housing of the windshield-level display device 200.

In some embodiments, the windshield-level display device 200 includes an adjustment mechanism that enables the position of the electronic view to be adjusted within the windshield view. For example, the projection output may be aimed higher/lower to enable the height (H) of the electronic view to accommodate the viewing height of the driver so that the driver is able to observe the electronic view over the steering wheel. In some arrangements, the height (H) is within a predefined range (e.g., six inches to 20 inches). Since only a portion of the windshield 220 includes the electronic view (e.g., the electronic view is positioned in the bottom half of the windshield 220 in FIG. 2), the electronic view does not impede the driver's ability to take in the environment through the windshield view. In some arrangements, the projection output may be further adjusted (e.g., moved to horizontally the left or right, enlarged/shrunk, combinations thereof, etc.).

Additionally, in some embodiments, the windshield-level display device 200 is suitable for being disposed in front of windshield 220, and behind the windshield 220. In any of these embodiments, a user is able to set (e.g., via a switch or parameter, etc.) whether the windshield-level display device 200 is disposed in front of or behind the windshield 220, and the windshield-level display device 200 outputs the projection 210 appropriately (e.g., as a normal image/projection or as a reverse image/projection).

Furthermore, by way of example only, the projection 210 is shown as appearing on a bottom part (or bottom half) of the windshield 220 (also see the bottom portion 120(B) in FIG. 1). However, it should be understood that the location of the projection 210 is not limited to just the bottom part of the windshield 220. In some embodiments, the projection 210 is located in other windshield areas such as the upper half, over both halves, driver side only, passenger side only, and so on.

As explained above, the windshield-level display device 200 in combination with the windshield 220 essentially forms a windshield-level display enabling a driver and/or passenger to view the projection 210 at a windshield-level height. By way of example, the projection 210 is shown as including a graphic 240 warning the occupants of the utility vehicle that there is a restricted area (e.g., a restricted geofenced area) ahead and perhaps other information. Along these lines, the graphic may simply be particular shape (e.g., a trapezoid, an upside down triangle, etc.) in a particular color (e.g., yellow for a simple warning, red to immediately stop, etc.) depending on the type of notification. Moreover, other effects may be included (e.g., blinking/non-blinking, audio sounds, pedal vibration, combinations thereof, etc.).

As shown in FIG. 3, the windshield-level display device 300 is a monitor style apparatus which presents visual output 310 containing utility vehicle information (also see FIG. 1). The windshield-level display device 300 may be constructed and arranged to receive an electronic display signal 330 and render the visual output 310 (i.e., an electronic view of utility vehicle information) based on the electronic display signal 330.

In some arrangements, the windshield-level display device 300 is constructed and arranged to reside between the windshield section 118 of the utility vehicle 100 and the seating section 116 of the utility vehicle 100 (e.g., see FIG. 1). Along these lines, the electronic view may be positioned within the windshield view at a height (H) (e.g., six inches, eight inches, etc.) above a bottom of the windshield view (or above the bottom of the windshield section 118, or the above the top of the dashboard section 114, etc.) thus enabling the driver to easily see the electronic view above the steering wheel of the vehicle 100. In these arrangements, the windshield-level display device 300 outputs light directly toward passengers. Such arrangements are well suited for situations in which the windshield-level display device 300 is able to conveniently/easily mount in front of the windshield 320 (e.g., directly on top of a dashboard, directly on to a steering column, etc.).

In other arrangements, the windshield section 118 of the utility vehicle 100 is between the windshield-level display device 300 and the seating section 116 of the utility vehicle 100 (e.g., see FIG. 1). In these arrangements, the windshield-level display device 300 outputs light through the windshield 320 enabling passengers to view the visual output 310 through the windshield section 118 (e.g., the bottom portion 120(B) of the windshield 120 in FIG. 1). Such arrangements are well suited for situations in which the windshield-level display device 300 is able to conveniently/easily mount behind the windshield 320 (e.g., on a front portion of the utility vehicle body 102, on a hood of the utility vehicle 100, etc.).

In some embodiments, the windshield-level display device 300 is supported by an adjustment mechanism 340 that enables the position of the electronic view to be adjusted within the windshield view. For example, the adjustment mechanism 340 may take the form of an adjustable support (or base) so that the driver is able to observe the electronic view over the steering wheel. In some arrangements, the height (H) is within a predefined range (e.g., six inches to 20 inches). Since the electronic view resides only within a portion of the windshield view (e.g., the electronic view is positioned within a bottom half of the windshield view in FIG. 3), the electronic view does not impede the driver's ability to take in the environment through the windshield view. In some arrangements, the adjustment mechanism 340 may be further adjusted (e.g., moved to horizontally the left or right, diagonally, etc.).

It should be understood that the windshield-level display device 300 may be provided in a variety of different forms. Examples include LCD, LED, other types of crystal displays, CRT, flexible display material that affixes to the windshield 320, anti-glare glass, combinations thereof, and so on.

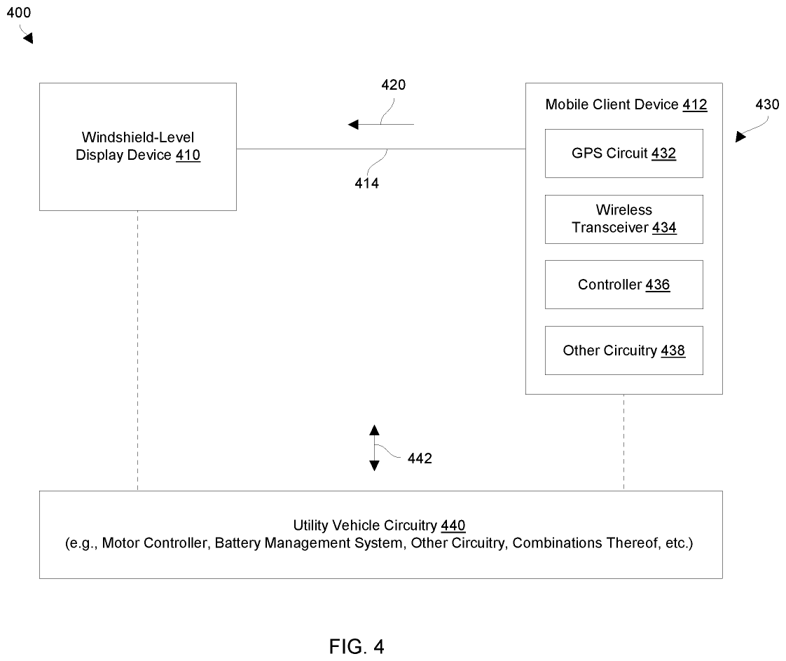

It should be understood that even if the windshield 320 is folded (i.e., the top half is folded over the bottom half via a hinge), the driver is still able to see both the windshield view of the environment in front of the utility vehicle and the electronic view provided by the windshield-level display device 300. Moreover, the windshield-level display device 300 does not require any modifications to the windshield 320 of the utility vehicle in order to accommodate the windshield-level display device 300. By way of example, the visual output 310 includes a graphic 340 warning the occupants of the utility vehicle that there is a restricted area (e.g., a restricted geofenced area) ahead and perhaps other information (e.g., based on shape, color, blinking/non-blinking, etc.). Further details will now be provided with reference to FIG. 4.

FIG. 4 shows a windshield-level display kit 400 in accordance with certain embodiments. The windshield-level display kit 400 is constructed and arranged to install on a utility vehicle during manufacturing such that the utility vehicle is fully equipped to enable a driver of to access a view of electronic information which is at windshield-level upon shipping. Additionally, the windshield-level display kit 400 is able to upgrade legacy utility vehicles into an improved utility vehicle that enables a driver to simultaneously see, at windshield-level, a windshield view of what is ahead of the utility vehicle and a view of electronic information. As shown in FIG. 4, the windshield-level display kit 400 includes a windshield-level display device 410, a mobile client device 412, and a connection 414.

The windshield-level display device 410 is constructed and arranged to couple with a utility vehicle body and to provide the driver of the golf cart with an electronic view of utility vehicle information (e.g., also see FIGS. 1 through 3). As mentioned earlier, the windshield view of the environment in front of the utility vehicle and the electronic view of the utility vehicle information is provided at a same height to the driver of the utility vehicle. Accordingly, the driver may access the electronic view while still focusing on the path ahead of the utility vehicle.

The mobile client device 412 is constructed and arranged to provide an electronic display signal 420 to the windshield-level display device 410 through the connection 414. The electronic display signal includes utility vehicle information which is then rendered by the windshield-level display device 410.

As shown in FIG. 4, the mobile client device 412 includes a variety of circuits 430. In accordance with certain embodiments, such circuits 430 include a global positioning system (GPS) circuit 432, a wireless transceiver 434, a controller 436, and other circuitry 438. The GPS circuit 432 is constructed and arranged to identify a geolocation of the mobile client device 412 such that, when the mobile client device 412 is installed on and made operative on the utility vehicle, the GPS circuit 432 indicates a current location of the utility vehicle. The wireless transceiver 434 is constructed and arranged to enable the mobile client device 412 to communicate with other external circuitry (e.g., a base station, a wireless network, a cellular network, other devices, combinations thereof, etc.). The controller 436 is constructed and arranged to provide the electronic display signal 420. The other circuitry 438 represents other resources of the mobile client device 412 (e.g., a vehicle interface to interface with utility vehicle circuitry 440, computerized memory/storage, a repository of geofences to enable the mobile client device 412 to determine current position relative to predefined geofences, a power supply, etc.).

In some arrangements, the controller 436 includes a set of processors which is constructed and arranged to operate in accordance with the various software constructs stored in computerized memory. Along these lines, the set of processors executes specialized code to form specialized circuitry that robustly and reliably provides the electronic display signal 420. Such specialized circuitry may be implemented in a variety of ways including via one or more processors (or cores) running specialized software, application specific ICs (ASICs), field programmable gate arrays (FPGAs) and associated programs, discrete components, analog circuits, other hardware circuitry, combinations thereof, and so on. In the context of one or more processors executing software, a computer program product is capable of delivering all or portions of the software to the mobile client device 412. Such a computer program product has a non-transitory (or non-volatile) computer readable medium which stores a set of instructions that controls one or more operations of the set of processors. Examples of suitable computer readable storage media include tangible articles of manufacture and apparatus which store instructions in a non-volatile manner such as DVD, CD-ROM, flash memory, disk memory, tape memory, and the like.

The connection 414 couples the windshield-level display device 410 and the mobile client device 412 together. The connection 414 may take the form of a cable, a connector, combinations thereof, etc. In addition to carrying the electronic display signal 420 to the windshield-level display device 410 from the mobile client device 412, the connection 414 may carry other signals such as control/status signals from the windshield-level display device 410 to the mobile client device 412, power signals, and so on.

In some embodiments, the windshield-level display device 410 and/or the mobile client device 412 further connect with utility vehicle circuitry 440. For example, such connectivity enables the various components of the windshield-level display kit 400 to access parts of the utility vehicle such as a motor controller, a battery management system, other resources of the utility vehicle, and so on (also see the motion control system 106 in FIG. 1). Along these lines, the various components of the windshield-level display kit 400 are able to exchange various signals 442 (e.g., control/status signals, power, etc.). In some arrangements, the mobile client device 412 communicates with other circuits of the utility vehicle via a CAN bus.

In accordance with certain embodiments, the utility vehicle is a golf cart. Along these lines, it should be appreciated that the task of driving the golf cart may require looking for golf balls, dropping off golfing passengers, picking up golfing passengers, traversing fairways/roughs/bridges/parking lots/etc., and so on. Accordingly, the task of driving the golf cart involves maneuvering the golf cart over a variety of terrain such as uphill slopes, downhill slopes, side hill slopes, pavement, dirt, grass, puddles, bridges, around bunkers and waste areas, trees, to and from tee boxes and greens, and so on.

During such time, the driver may wish to be aware of certain golf cart information such as the current distance of the golf cart to the pin (or flag) on the green, the number of the golf course hole the driver is currently playing, whether a rain shower is approaching, the direction to the next tee box, whether there is a restricted area or hazard up ahead, whether the golf cart is allowed to drive on a particular golf course area, and so on. Advantageously, certain improvements disclosed herein are able to provide the golf cart driver with access to such information at windshield-level. That is, the windshield view of the environment in front of the vehicle and an electronic view of such information are provided at a same height to the golf cart driver. Accordingly, the golf cart driver does not need to look away from the windshield and may instead see the electronic view while still focusing on the path ahead.

In some embodiments, the GPS circuit 432 identifies a current geolocation of the golf cart, and the controller 436 identifies a current golf course hole of a golf course and include golf hole information within the electronic display signal 420 that is provided to the windshield-level display device 410 based on the current geolocation of the golf cart. Such golf hole information may include an identification of the current golf course hole, an overall distance for the current golf course hole, a current distance between the golf cart and a pin (or flag) location of the current golf course hole based on the current geolocation, current pace of play, and so on. The mobile client device 412 may even report the current geolocation back to a base station (e.g., a clubhouse, a golf cart shed, etc.).

In some embodiments, the GPS circuit 432 identifies a current geolocation of the golf cart, and the controller 436 identifies various golf course information that is included within the electronic display signal. Such golf course information may include an identification of the current golf course and a set of geofenced areas surrounding the golf cart based on the current geolocation (e.g., upcoming out of bounds areas, restricted areas, areas having a lower speed limit, etc.).

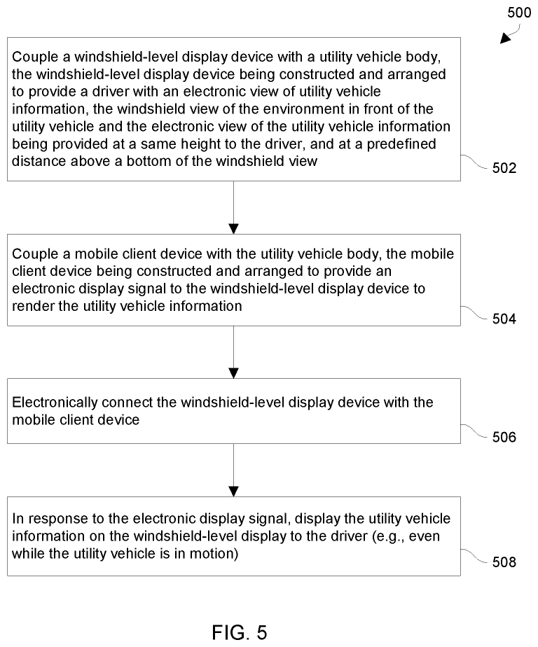

In some embodiments, the controller 436 is constructed and arranged to include a set of displayable messages within the electronic display signal that is provided to the windshield-level display device. Such displayable messages may include identification of golf course (or golf hole) sponsors, local or appropriate advertisements, real-time weather updates, informational notices such as requests to speed up pace of play, and so on. Further details will now be provided with reference to FIG. 5.

FIG. 5 is a flowchart of a procedure 500 for providing a driver of a utility vehicle (e.g., a golf cart) with a view of electronic information which is at windshield-level in accordance with certain embodiments. Such a procedure 500 may be performed by a manufacturer of the utility vehicle, a customer of a windshield-level display kit to upgrade an existing utility vehicle, and so on.

As mentioned earlier, such a utility vehicle has a utility vehicle body and a windshield supported by the utility vehicle body (also see FIG. 1). The windshield is constructed and arranged to provide the driver with a windshield view of an environment in front of the utility vehicle.

At 502, a windshield-level display device is coupled with the utility vehicle body. The windshield-level display device is constructed and arranged to provide the driver of the utility vehicle with the electronic view of utility vehicle information. The windshield view of the environment in front of (or ahead of) the utility vehicle and the electronic view of the utility vehicle information are provided at a same height to the driver of the utility vehicle.

At 504, a mobile client device is coupled with the utility vehicle body, the mobile client device being constructed and arranged to provide an electronic display signal to the windshield-level display device to render the utility vehicle information.

At 506, the windshield-level display device is electronically connected with the mobile client device. Along these lines, the windshield-level display device and the mobile client device may reside at different locations on the utility vehicle and such components may be connected together via a cable, connectors, etc. (e.g., see the connection 414 in FIG. 4). Moreover, 502 through 506 may be performed in different orders.

At 508, in response to the electronic display signal, the windshield-level display device displays the golf cart information on the windshield-level display to the driver (even while the utility vehicle is in motion). Accordingly, the driver is able to take in both the windshield view and the electronic view safely and simultaneously.

It should be understood that the position of the electronic view may be adjusted within the windshield view to accommodate different driver viewing heights, different utility vehicle geometries/layouts/configurations/etc., and so on. Along these lines, the predefined distance above the bottom of the windshield view may be adjusted from a first height to a second height that is different from the first height. That is, the electronic view may be moved from a first height of X inches above the bottom of the windshield view to a second height of Y inches above the bottom of the windshield view, where X and Y are positive integers. In some embodiments, the height is restricted within a predefined range (e.g., six inches to 20 inches above the bottom of the windshield view) thus preventing the electronic view from being rendered at inconvenient locations within the windshield view. In the context of a fleet of golf carts maintained by a golf course, such control over the location of the electronic view within the windshield view may be fixed (or restricted) by the golf course, or alternatively offered to golf cart drivers for customization.

As described above, improved techniques are directed to providing a driver of a utility vehicle 100 such as a golf cart with a view of electronic information which is at windshield-level. That is, the utility vehicle 100 may include a windshield 120 (or at least a windshield section 118, also see FIG. 1) that provides the driver with a windshield view of an environment in front of the vehicle 100. Additionally, a windshield-level display device provides an electronic view of electronic information. Both the windshield view of the environment in front of the vehicle 100 and the electronic view of the electronic information are provided at a same height to the driver of the vehicle 100. In some arrangements, the electronic view is positioned within the windshield view at a height (H) above the dashboard section 114 of the vehicle 100 (e.g., six inches, eight inches, etc.) thus enabling the driver to easily see the electronic view above the steering wheel of the vehicle 100. Accordingly, the driver does not need to look away from the windshield 120 (or the windshield section 118) and may instead see the electronic view while still focusing on the path ahead.

While various embodiments of the present disclosure have been particularly shown and described, it will be understood by those skilled in the art that various changes in form and details may be made therein without departing from the spirit and scope of the present disclosure as defined by the appended claims.

One should appreciate that the disclosed techniques of providing a view of electronic information at windshield-level is not simply providing data to a user. Rather, such disclosed techniques are improvements to utility vehicle technology. Along these lines, the driver is able to access pertinent utility vehicle information (e.g., current location, distance to hazardous/restricted areas, warnings, etc.) without having to look away from a windshield view of what is ahead of the utility vehicle. Such operation improves safety, driver awareness, and the overall driver experience. Moreover, in the context of a golf cart, such techniques identify pertinent golf cart information (e.g., current golf course hole, distant to the pin, pace of play, etc.).

It should be appreciated that conventional golf GPS systems may rely on an LCD screen either mounted above the operator's eyesight immediately below the vehicle canopy or mounted below the operator's eyesight on the vehicle dash. Both options result in the vehicle operator having to shift viewing focus from what is ahead of them to view what is displayed on the screens. In rare cases, the operator can become distracted and results in the vehicle being operated in and unsafe manner or in restricted areas.

However, an improved smart windshield disclosed herein integrates a golf course GPS system with windshield technology. Such integration of golf course GPS systems with smart windshields provides heads-up displays for increased safety and better user experiences.

One feature that may have become more prevalent in the automotive industry is the heads-up display on car windshields. Providing vehicle operators with vehicle telemetry displayed on the windshield may allow for the operator to keep eyes on the road while minimizing distractions creating a safer driving experience.

Certain improvements disclosed herein utilize GPS systems integrated into golf fleet vehicles to display information such as current hole, hole distance, distance from current location to pin, etc. The display can also show areas on the course that may be restricted to golf cart access to prevent vehicle lockdowns for entering restricted geofences. Users of the backend of the GPS system can send messages to golfers that would be displayed on the windshield. These features would allow for golfers to keep their eyes on what is ahead of them and provide a safer golf cart operating experience.

In accordance with certain embodiments, a golf course GPS device (or system) is integrated with a smart windshield heads-up display system. The GPS device has the ability to display golf course information such as hole graphics, hole information, hole distances, and current location of the cart on the hole. A smart windshield (or windshield projector) is formed by connecting the display device directly to the GPS device. The GPS device then sends data over a hardwired connection to the display device in real-time. The smart windshield or windshield projector is then able to display the information sent from the GPS device in a way that allows the vehicle operator to focus on the path ahead and help avoid any obstacles.

It should be appreciated that nothing precludes the improved techniques from being used in combination with other mechanisms. For example, in some embodiments, information from other parts of the utility vehicle 100 are displayed in the electronic view provided by the windshield-level display device. Such information may include metrics from the motor controller, the BMS, other equipment of the utility vehicle 100, and so on.

Furthermore, it should be understood that the utility vehicle 100 was described in certain portions in the context of a golf cart. However, in other embodiments, the utility vehicle 100 performs other operations and specializes in other applications. Other types of vehicles include aircraft, watercraft, specialized vehicles, and so on. Such modifications and enhancements are intended to belong to various embodiments of the disclosure.

What is claimed is:

1. A golf cart, comprising:
a golf cart body;
a windshield supported by the golf cart body, the windshield being constructed and arranged to provide a driver of the golf cart with a windshield view of an environment in front of the golf cart; and
a windshield-level display device coupled with the golf cart body, the windshield-level display device being constructed and arranged to provide the driver of the golf cart with an electronic view of provided information, the windshield view of the environment in front of the golf cart and the electronic view of the provided information being provided at a same height to the driver of the golf cart, and the electronic view being provided at a predefined distance above a bottom of the windshield view.

2. The golf cart of claim 1 wherein the golf cart body includes (i) a canopy that serves as a roof to the golf cart and (ii) a dashboard; and
wherein the windshield view of the environment in front of the golf cart and the electronic view of the provided information reside at a height which is above the dashboard and at least eight inches below the canopy.

3. The golf cart of claim 2, further comprising:
a mobile client device which couples with the windshield-level display device, the mobile client device being constructed and arranged to provide an electronic display signal to the windshield-level display device to render the provided information on a windshield-level display.

4. The golf cart of claim 3 wherein the windshield-level display device includes a projection apparatus that is constructed and arranged to project the provided information on to the windshield in response to the electronic display signal.

5. The golf cart of claim 3 wherein the windshield-level display device includes an electronic screen that is constructed and arranged to display the provided information in place of a portion of the windshield view in response to the electronic display signal.

6. The golf cart of claim 3 wherein the mobile client device includes global positioning system (GPS) circuitry and a controller;
wherein the GPS circuitry is constructed and arranged to identify a current geolocation of the golf cart; and
wherein the controller is constructed and arranged to identify a current golf course hole of a golf course and include hole information within the provided information that is provided to the windshield-level display device based on the current geolocation of the golf cart.

7. The golf cart of claim 6 wherein the hole information that is included within the provided information includes an identification of the current golf course hole, an overall distance for the current golf course hole, and a current distance between the golf cart and a pin location of the current golf course hole based on the current geolocation.

8. The golf cart of claim 3 wherein the mobile client device includes global positioning system (GPS) circuitry and a controller;
wherein the GPS circuitry is constructed and arranged to identify a current geolocation of the golf cart; and
wherein the controller is constructed and arranged to identify a current golf course and include course information within the provided information that is provided to the windshield-level display device based on the current geolocation of the golf cart.

9. The golf cart of claim 8 wherein the course information that is included within the provided information includes an identification of the current golf course and a set of geofenced areas surrounding the golf cart based on the current geolocation.

10. The golf cart of claim 3 wherein the mobile client device includes a controller which is constructed and arranged to include a set of displayable messages within the provided information that is provided to the windshield-level display device.

11. The golf cart of claim 10 wherein the set of displayable messages include golf course sponsors, advertisements, and real-time weather updates.

12. The golf cart of claim 3 wherein the mobile client device includes global positioning system (GPS) circuitry and a controller;
wherein the GPS circuitry is constructed and arranged to identify a current geolocation of the golf cart; and
wherein the controller is constructed and arranged to (i) identify a current golf course hole and include hole information within the provided information that is provided to the windshield-level display device based on the current geolocation of the golf cart, (ii) identify a current golf course and include course information within the provided information that is provided to the windshield-level display device based on the current geolocation of the golf cart, and (iii) include a set of displayable messages within the provided information that is provided to the windshield-level display device.

13. A windshield-level display kit for a golf cart having a golf cart body and a windshield supported by the golf cart body, the windshield being constructed and arranged to provide a driver of the golf cart with a windshield view of an environment in front of the golf cart, the windshield-level display kit comprising:
a windshield-level display device constructed and arranged to couple with the golf cart body, and to provide the driver of the golf cart with an electronic view of provided information, the windshield view of the environment in front of the golf cart and the electronic view of the provided information being provided at a same height to the driver of the golf cart, and the electronic view being provided at a predefined distance above a bottom of the windshield view; and
a mobile client device which couples with the windshield-level display device, the mobile client device being constructed and arranged to provide an electronic display signal to the windshield-level display device to render the provided information on a windshield-level display.

14. The windshield-level display kit of claim 13 wherein the mobile client device includes global positioning system (GPS) circuitry and a controller;
wherein the GPS circuitry is constructed and arranged to identify a current geolocation of the golf cart; and
wherein the controller is constructed and arranged to (i) identify a current golf course hole and include hole information within the provided information that is provided to the windshield-level display device based on the current geolocation of the golf cart, (ii) identify a current golf course and include course information within the provided information that is provided to the windshield-level display device based on the current geolocation of the golf cart, and (iii) include a set of displayable messages within the provided information that is provided to the windshield-level display device.

15. The windshield-level display kit of claim 14 wherein the windshield-level display device includes a projection apparatus that is constructed and arranged to project the provided information on to the windshield in response to the electronic display signal.

16. The windshield-level display kit of claim 14 wherein the windshield-level display device includes an electronic screen that is constructed and arranged to display the provided information in place of a portion of the windshield view in response to the electronic display signal.

17. A method of providing a driver of a golf cart with an electronic view of provided information, the golf cart having a golf cart body and a windshield supported by the golf cart body, the windshield being constructed and arranged to provide the driver of the golf cart with a windshield view of an environment in front of the golf cart, the method comprising:
coupling a windshield-level display device with the golf cart body, the windshield-level display device being constructed and arranged to provide the driver of the golf cart with the electronic view of the provided information, the windshield view of the environment in front of the golf cart and the electronic view of the provided information being provided at a same height to the driver of the golf cart, and the electronic view being provided at a predefined distance above a bottom of the windshield view;
coupling a mobile client device with the golf cart body, the mobile client device being constructed and arranged to provide an electronic display signal to the windshield-level display device to render the provided information on a windshield-level display; and
electronically connecting the windshield-level display device with the mobile client device.

18. The method of claim 17, further comprising:
in response to the electronic display signal, displaying the provided information on the windshield-level display to the driver while the golf cart is in motion.

19. The method of claim 17, further comprising:
adjusting the predefined distance above the bottom of the windshield view from a first height to a second height that is different from the first height to move the electronic view within the windshield view.
